(19) United States
(12) Patent Application Publication
(10) Pub. No.: US 2021/0156658 A1
(43) Pub. Date: May 27, 2021

(54) Hub Gauge Device For Determining Hub Dimensions Relevant For Wheel Building

(71) Applicant: Travis Anderson, Sparks, NV (US)

(72) Inventor: Travis Anderson, Sparks, NV (US)

(21) Appl. No.: 16/693,201

(22) Filed: Nov. 22, 2019

(51) Int. Cl. G01B 3/20; B60B 31/02

(52) U.S. Cl. CPC G01B 3/20; B60B 31/02

(57) ABSTRACT

The hub gauge device allows a user to quickly and accurately determine the precise center of a bicycle hub by placing the bicycle hub into a hub gauge device in a horizontal orientation. Once the center is determined, one or more relevant hub dimensions may be determined. The hub gauge device includes an adjustable hub rest having a first support and a second support, allowing the user to place the bicycle hub into the hub gauge device so that one hub axle is supported by the first support and the second hub axle is supported by the second support. The first support and the second support are each adjustably connected to a gear assembly, allowing for coordinated movement of the supports in relation to a fixed center point of the hub gauge device; in other words, the first support and the second support move in concert and thus remain equidistant to the fixed center point. Once the user has placed the bicycle hub into the adjustable hub rest, the gear assembly facilitates automatic centering of the bicycle hub within the hub gauge device and thus a precise center point of the bicycle hub is indicated by the center point marked on the fixed indicator. Once the center of the bicycle hub is determined, other dimensions relevant to bicycle repair, including flange-to-center dimensions, pitch circle or flange diameters, or spoke hole diameters, may be read and/or calculated.

### SUMMARY OF THE INVENTION

The present invention is generally related to bicycles and bicycle repair, and more particularly related to devices and methods for determining one or more dimensions relevant for bicycle wheel building. A device for determining one or more bicycle hub dimensions comprises an adjustable hub rest for receiving the bicycle hub, a fixed indicator for indicating a center point, and a pair of moveable caliper jaws for determining one or more flange-to-center dimensions.

The herein disclosed hub gauge device allows a user to quickly and accurately determine the precise center of a bicycle hub by placing the bicycle hub into a hub gauge device in a horizontal orientation, thus facilitating the determination of one or more hub dimensions. The hub gauge device includes an adjustable hub rest having a first support and a second support, allowing the user to place the bicycle hub into the hub gauge device so that one hub axle is supported by the first support and the second hub axle is supported by the second support. The first support and the second support are each adjustably connected to a gear assembly, allowing for coordinated movement of the supports in relation to a fixed center point of the hub gauge device; in other words, the first support and the second support move in concert and thus remain equidistant to the fixed center point. Once the user has placed the bicycle hub into the adjustable hub rest, the gear assembly facilitates automatic centering of the bicycle hub within the hub gauge device and thus a precise center point of the bicycle hub is indicated by the center point marked on the fixed indicator.

Once the center of the bicycle hub is determined, other dimensions relevant to bicycle repair may be read by a user and/or calculated by a user (or calculated automatically by the hub gauge device and/or by a processor communicatively connected to the hub gauge device). For example, a user can adjust each of the moveable caliper jaws to be in alignment with the hub flanges and then the user is able to read one or more center-to-flange dimensions directly from the fixed indicator. Or in an alternative embodiment, the hub gauge device may include a processor (or be communicatively coupled to a processor) and a positional sensing system to determine a location of the first moveable caliper jaw and a location for the second moveable caliper jaw. This embodiment may further include one or more display devices for displaying a left flange-to-center dimension, a right flange-to-center dimension, and/or any other relevant dimension that may be measured or calculated by the hub gauge device.

Furthermore, the herein disclosed hub gauge device can also include a capability to calculate or determine a pitch circle for a bicycle hub. In a preferred embodiment, each of the caliper jaws may include an extended beak that may be conical (or somewhat conical, similar to a thin crochet needle) in shape. After locking one of the caliper jaws in place at the fixed center point, user can turn the bicycle hub on end (so that it is oriented vertically) and place the bicycle hub over the extended beak of the locked caliper jaw. The use may then move, or slide, the other caliper jaw to determine a pitch circle dimension or a flange diameter dimension. The caliper jaw extended beak(s) may be marked incrementally to determine one or more spoke hole diameter dimensions. An extended beak having at least a portion with a relatively large diameter, such as a conical shape that forms a relatively severe slope for example, may accommodate even bicycle hubs having larger or oversized holes designed to accommodate over-sized gauge spokes.

A preferred embodiment of the present invention comprises: an adjustable hub rest for receiving the bicycle hub, wherein the adjustable hub rest has a first support adjustably connected to a gear assembly, a second support adjustably connected to the gear assembly, and wherein the first support and the second support move in coordination in relation to a center point of the device; and a fixed indicator for marking the center point of the device and displaying increments along the length of travel of the adjustable hub rest, wherein the fixed indicator includes a first moveable caliper jaw for slidably moving along the fixed indicator and a second moveable caliper jaw for slidably moving along the fixed indicator.

A preferred embodiment of a method for determining one or more relevant hub dimensions comprises the steps of: receiving a bicycle hub into an adjustable hub rest of a hub gauge device, wherein the adjustable hub rest has a pair of supports connected to a gear assembly such that the pair of supports moves in coordination to remain equidistant from a center point; indicating a center of the hub by a fixed position indicator fixed to the hub gauge device; aligning a first moveable caliper jaw with a first flange of the bicycle hub and a second moveable caliper jaw with a second flange of the bicycle hub; receiving a first moveable caliper jaw position location and a second moveable caliper jaw position location; and calculating a left flange-to-center dimension and a right flange-to-center dimension by utilizing the first moveable caliper jaw position location and the second moveable caliper jaw position location.

Alternative embodiments for the present invention can also include connectively coupling the hub gauge device to a computer, a tablet such as an ipad, a mobile device, or a smart device to automatically populate a spoke calculator. Another embodiment of the present invention may include a digital representation of an adjustable hub rest, wherein a user places a bicycle hub on the digital representation of the adjustable hub rest—on a touch screen tablet device, for example—and then the center point and the relevant dimensions may be calculated or determined through a combination of user input and hub flange positions which may be sensed through the touch screen.

### CROSS-REFERENCES TO RELATED APPLICATIONS

No applicable.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK.

Not applicable.

### BACKGROUND OF THE INVENTION

When building or repairing bicycle wheels, it is helpful and preferred to start by locating the center of the bicycle hub. Well known methods for determining a center of a bicycle hub involve a series of measurements by a bicycle technician using paper, a ruler, a digital caliper, a pencil, and perhaps 15 to 30 minutes of tedious work. Very often, short cuts are taken and the precision of the bicycle wheel build will suffer. Even if a well-trained technician utilizes all the proper tools and takes his or her time, the method assumes that the hub width is perfect—which is never actually the case in the real world. Once the center of the hub is located, one or more relevant bicycle hub dimensions may be determined relatively quickly and accurately.

It would therefore be advantageous to provide a means for more easily locating a center of a bicycle hub. The herein disclosed hub gauge device provides a device that self-centers the bicycle hub in a horizontal orientation so that the center is indicated by a fixed point on the hub gauge device. In this way, the need for several separate tools and squinty-eyed manual measurements is eliminated and methods for determining the center of a bicycle hub and additional hub dimensions, such as center-to-flange dimensions, can be made easier and more efficient.

### BRIEF DESCRIPTION OF THE SEVERAL VIEWS OF THE DRAWING

FIG. 1 illustrates a front view of the herein disclosed device for determining one or more relevant bicycle hub dimensions, wherein the first moveable caliper jaw and the second moveable caliper jaw are positioned at the center point of the huge gage device, in accordance with a preferred embodiment of the present invention;

FIG. 2 illustrates an isometric view of the herein disclosed device for determining one or more relevant bicycle hub dimensions, wherein the first moveable caliper jaw and the second moveable caliper jaw are positioned at the center point of the huge gage device, in accordance with a preferred embodiment of the present invention;

FIG. 3 illustrates a front view of the herein disclosed device for determining one or more relevant bicycle hub dimensions, wherein a bicycle hub is positioned on the adjustable hub rest, the first moveable caliper jaw is positioned at a first flange of the bicycle hub, and the second moveable caliper jaw is positioned at a second flange of the bicycle hub, in accordance with a preferred embodiment of the present invention; and

FIG. 4 illustrates an isometric view of the herein disclosed device for determining one or more relevant bicycle hub dimensions, wherein a bicycle hub is positioned on the adjustable hub rest, the first moveable caliper jaw is positioned at a first flange of the bicycle hub, and the second moveable caliper jaw is positioned at a second flange of the bicycle hub, in accordance with a preferred embodiment of the present invention.

### DETAILED DESCRIPTION OF THE INVENTION

The present invention is a hub gauge device for determining one or more relevant bicycle hub dimensions. A preferred embodiment of the hub gauge device comprises: an adjustable hub rest for receiving the bicycle hub, wherein the adjustable hub rest has a first support adjustably connected to a gear assembly, a second support adjustably connected to the gear assembly, and wherein the first support and the second support move in coordination in relation to a center point of the device; and a fixed indicator for marking the center point of the device and displaying increments along the length of travel of the adjustable hub rest, wherein the fixed indicator includes a first moveable caliper jaw for slidably moving along the fixed indicator and a second moveable caliper jaw for slidably moving along the fixed indicator. In certain embodiments, the fixed indicator is fixed to a hub gauge frame and the gear assembly is also fixed to the hub gauge frame so that the first support and the second support move in coordination in relation to a hub gauge frame having a constant or fixed position.

The present invention is also a method for locating the center of a bicycle hub and/or determining one or more relevant hub dimensions. A preferred embodiment of the method for determining one or more relevant hub dimensions includes the steps of: receiving a bicycle hub into an adjustable hub rest of a hub gauge device, wherein the adjustable hub rest has a pair of supports connected to a gear assembly such that the pair of supports move in coordination to remain equidistant from a center point; indicating a center of the hub by a fixed position indicator fixed to the hub gauge device; aligning a first moveable caliper jaw with a first flange of the bicycle hub and a second moveable caliper jaw with a second flange of the bicycle hub; receiving a first moveable caliper jaw position location and a second moveable caliper jaw position location; and calculating a left flange-to-center dimension and a right flange-to-center dimension by utilizing the first moveable caliper jaw position location and the second moveable caliper jaw position location. Certain embodiments may further include the step of displaying the left flange-to-center dimension and the right flange-to-center dimension on one or more display devices; the display devices may be positioned on the hub gauge frame or on one or both of the moveable calipers.

Throughout this specification, the physical location in the middle of the fixed indicator will be referred to as the center point on the indicator (or the center point of the hub gauge device). But this physical location may also be referred to as zero (0) or the zero point. The fixed indicator is incremented from the center outward so that points equidistant from the center point on each side read the same (or as inverses of each other; one side may be labeled as positive and the other side may be labeled as negative).

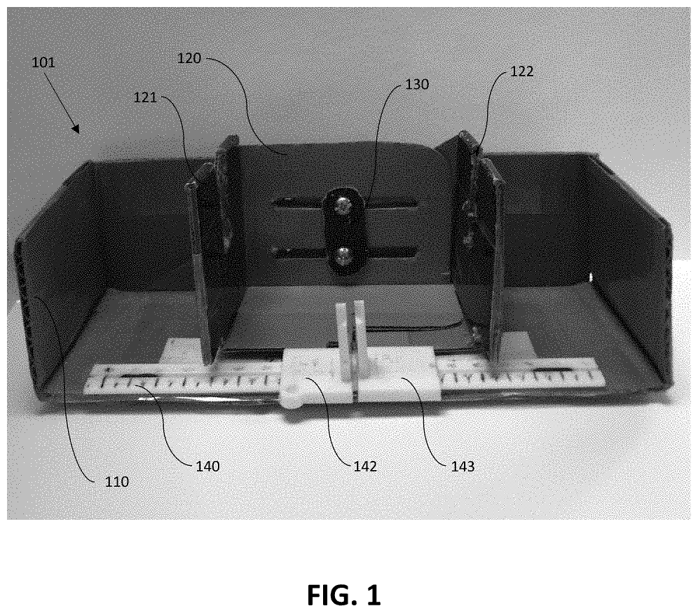

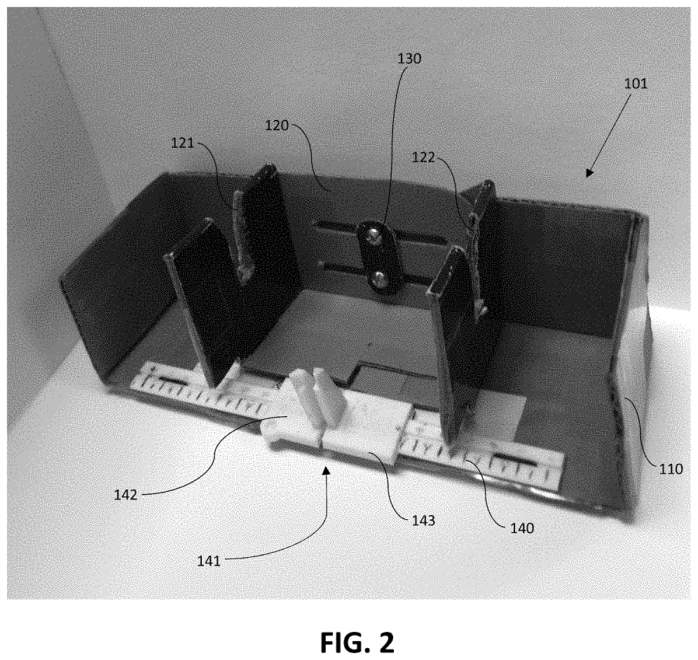

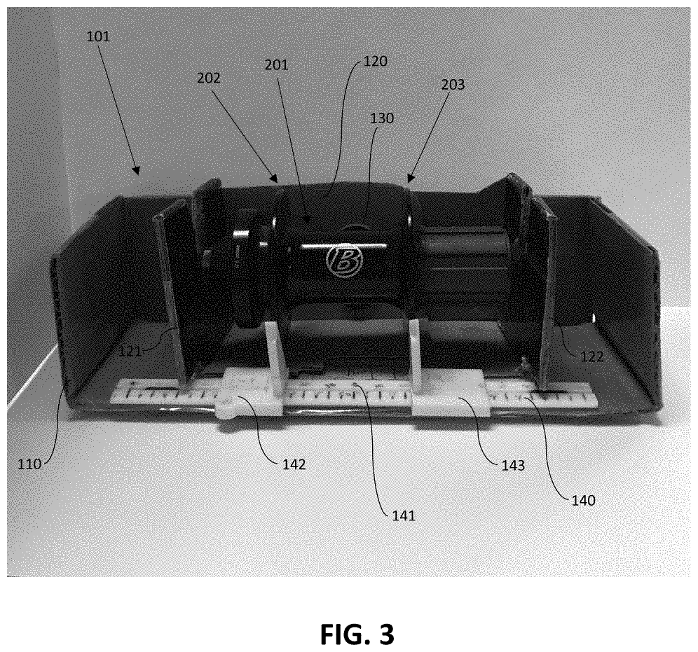

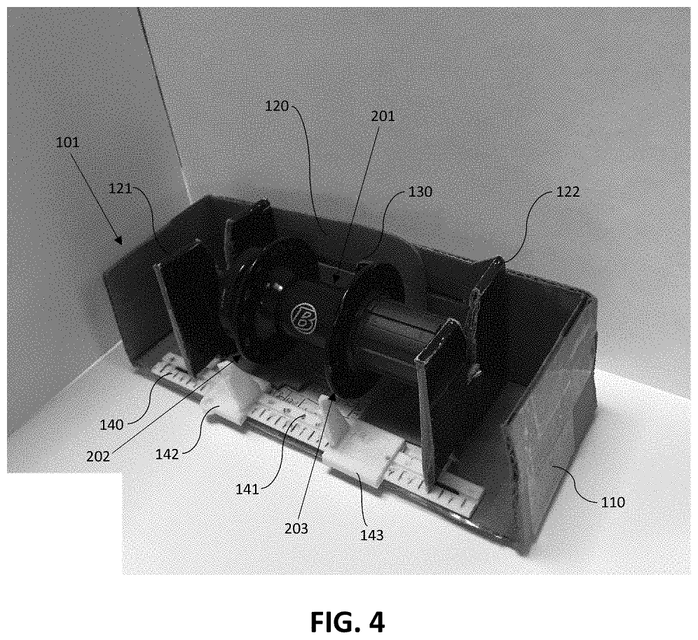

Referring to FIG. 1 and FIG. 2, the present invention device for determining one or more relevant bicycle hub dimensions is shown first without a bicycle hub (and is shown with a bicycle hub in FIG. 3 and FIG. 4). Hub gauge device 101 includes hub gauge frame 110 providing a rigid base on which to affix fixed indicator 140 so that the center point (or the zero point) as indicated on fixed indicator is located at the center, horizontally, of hub gauge frame 110. Hub gauge frame 110 may be of any shape and made of any material; the rectangular shape of hub gauge frame 110 as depicted in the various figures is only provided as an example. Fixed indicator 140 may alternatively be referred to as a ruler, a rule, or a fixed scale and indicates the center of hub gauge device 101 with an indication such as the number “0”, for example. Fixed indicator 140 may be a separate and/or distinct component from hub gauge frame 110, but alternatively fixed indicator 140 may be formed with, or simply drawn onto or formed through, a portion of hub gauge frame 110. Fixed indicator 140 includes first moveable caliper jaw 142 and second moveable caliper jaw 143. First moveable caliper jaw 142 and second moveable caliper jaw 143 are capable of slidably moving along fixed indicator 140 so that they may be positioned by a user. When calculating flange-to-center dimensions, a user positions first moveable caliper jaw 142 in alignment with a first flange of the bicycle hub and second moveable caliper jaw 143 in alignment with a second flange of the bicycle hub. Such alignment may be undertaken by the user by eye; in alternative embodiments moveable caliper jaws 142 and 143 may each include a protrusion that allows for interference with the respective flanges to position precisely.

As seen in FIG. 1 and FIG. 2, moveable caliper jaws 142 and 143 are both positioned at center point 141; center point 141 is concealed by the movable caliper jaws 142 and 143 in FIG. 1 and FIG. 2. Center point 141 is visible in FIG. 3 and FIG. 4.

Hub gauge device 101 further includes adjustable hub rest 120 for receiving a bicycle hub. Adjustable hub rest 120 includes first support 121 and second support 122 and is functionally fixed to hub gauge frame 110 at gear assembly 130. Adjustable hub rest 120 may be formed of any material that can provide enough rigidity to support most bicycle hubs. First support 121 and second support 122 are connected to gear assembly 130 in such a way that they are capable of moving in coordination (or concert) in relation to center point 141. In other words, first support 121 and second support 122 remain equidistant in relation to center point 141, even as a first support 121 and second support 122 move to accommodate bicycle hubs of various sizes. Gear assembly 130 may be any type or arrangement of gears capable of facilitating the equidistant and coordinated movement of the moveable caliper jaws 142 and 143.

In certain embodiments as described herein, one or more display devices may be utilized to display one or more relevant hub dimensions determined or calculated by the herein disclosed devices and methods. For example, a single display may be fixed to hub gauge frame 110 that displays a right flange-to-center dimension and a left flange-to-center dimension. In an alternative example, moveable caliper jaw 142 may include a relatively small display device fixed to the flat portion of the slidable component that is capable of displaying a left flange-to-center dimension. In this example, moveable caliper jaw 143 may also include a second relatively small display device fixed to the flat portion of the slidable component that is capable of displaying a right flange-to-center dimension. Alternatively, hub gauge device 101 may connect to an external smart device (such as a computer, a tablet, or a mobile device, for example) to display one or more relevant dimension on the smart device's display device or to populate a spoke calculator running on the smart device.

Referring to FIG. 3 and FIG. 4, the herein disclosed device 101 for determining one or more relevant bicycle hub dimensions is shown with bicycle hub 201 in position within first support 121 and second support 122 of adjustable hub rest 120. In a preferred embodiment and as depicted in FIG. 3 and FIG. 4, first support 121 and second support 122 each form a v-shaped notch for receiving an axle of bicycle hub 201. Adjustable hub rest 120 is adjusted horizontally so that first support 121 is sufficiently apart from second support 122 to allow for bicycle hub 201 to fit. As discussed herein, gear assembly 130 facilitates first support 121 remaining equidistant from second support 122 in relation to center point 141. Because the supports remain equidistant, the center of bicycle hub 201 is now indicated by the center point 141.

A user can align first moveable caliper jaw 142 with left flange 202 of bicycle hub 201 and second moveable caliper jaw 143 with right flange 202 of bicycle hub 201. With the moveable calipers jaws 142 and 143 aligned with flanges 202 and 203, readings or calculations can be done of the left flange-to-center dimension and the right flange-to-center dimension.

While the present invention has been illustrated and described herein in terms of a preferred embodiment and several alternatives, it is to be understood that the devices and methods described herein can have a multitude of additional uses and applications. Accordingly, the invention should not be limited to just the particular description and various drawing figures contained in this specification that merely illustrate a preferred embodiment and application of the principles of the invention.

What is claimed is:

1. A device for determining one or more relevant dimensions of a bicycle hub, comprising:
an adjustable hub rest for receiving the bicycle hub, wherein the adjustable hub rest has a first support adjustably connected to a gear assembly, a second support adjustably connected to the gear assembly, and wherein the first support and the second support move in coordination in relation to a center point of the device; and
a fixed indicator for marking the center point of the device and displaying increments along a length of travel of the adjustable hub rest, wherein the fixed indicator includes a first moveable caliper jaw for slidably moving along the fixed indicator and a second moveable caliper jaw for slidably moving along the fixed indicator.

2. The device for determining one or more relevant dimensions of a bicycle hub as recited in claim 1, wherein the first support and the second support are connected to the gear assembly so that they remain equidistant from the center point of the device at all times during movement.

3. The device for determining one or more relevant dimensions of a bicycle hub as recited in claim 1, further comprising a processor and a positional sensing system to determine a first moveable caliper jaw location and a second moveable caliper jaw location.

4. The device for determining one or more relevant dimensions of a bicycle hub as recited in claim 3, wherein the processor utilizes the first moveable caliper jaw location and the second moveable caliper jaw location to determine one or more relevant hub dimensions.

5. The device for determining one or more relevant dimensions of a bicycle hub as recited in claim 4, wherein the one or more relevant hub dimensions are selected from a group consisting of a left flange-to-center dimension, a right-flange-to-center dimension, a pitch circle dimension, a flange diameter dimension, a spoke hole diameter.

6. The device for determining one or more relevant dimensions of a bicycle hub as recited in claim 1, further comprising one or more display screen for displaying one or more relevant hub dimensions.

7. The device for determining one or more relevant dimensions of a bicycle hub as recited in claim 6, wherein the one or more display screens includes a first moveable caliper display screen for displaying a left flange-to-center dimension and a second movable caliper display screen for displaying a right flange-to-center dimension.

8. The device for determining one or more relevant dimensions of a bicycle hub as recited in claim 1, wherein the device may communicatively connect to an external smart device to automatically populate a spoke calculator.

9. A device for determining one or more relevant dimensions of a bicycle hub, comprising:
an adjustable hub rest for receiving the bicycle hub, wherein the adjustable hub rest has a first support adjustably connected to a gear assembly, a second support adjustably connected to the gear assembly, and wherein the first support and the second support move in coordination in relation to a center point of the device; and
a hub gauge device frame having a fixed indicator for marking the center point of the device and displaying increments along a length of the hub gauge device frame, wherein the fixed indicator includes a first moveable caliper jaw for slidably moving along the fixed indicator and a second moveable caliper jaw for slidably moving along the fixed indicator;
wherein the gear assembly is fixed to the hub gauge device frame.

10. The device for determining one or more relevant dimensions of a bicycle hub as recited in claim 9, wherein the first support and the second support are connected to the gear assembly so that they remain equidistant from the center point of the device at all times during movement.

11. The device for determining one or more relevant dimensions of a bicycle hub as recited in claim 9, further comprising a processor and a positional sensing system to determine a first moveable caliper jaw location relative to the center point and a second moveable caliper jaw location relative to the center point.

12. The device for determining one or more relevant dimensions of a bicycle hub as recited in claim 11, wherein the processor utilizes the first moveable caliper jaw location and the second moveable caliper jaw location to determine one or more relevant hub dimensions.

13. The device for determining one or more relevant dimensions of a bicycle hub as recited in claim 12, wherein the one or more relevant hub dimensions are selected from a group consisting of a left flange-to-center dimension, a right-flange-to-center dimension, a pitch circle dimension, a flange diameter dimension, a spoke hole diameter.

14. The device for determining one or more relevant dimensions of a bicycle hub as recited in claim 9, further comprising one or more display screen for displaying one or more relevant hub dimensions.

15. The device for determining one or more relevant dimensions of a bicycle hub as recited in claim 14, wherein the one or more display screens includes a first moveable caliper display screen for displaying a left flange-to-center dimension and a second movable caliper display screen for displaying a right flange-to-center dimension.

16. The device for determining one or more relevant dimensions of a bicycle hub as recited in claim 9, wherein the device may communicatively connect to an external smart device to automatically populate a spoke calculator.

17. A method for determining one or more relevant hub dimensions, comprising the steps of:
receiving a bicycle hub into an adjustable hub rest of a hub gauge device, wherein the adjustable hub rest has a pair of supports connected to a gear assembly such that the pair of supports moves in coordination to remain equidistant from a center point;
indicating a center of the hub by a fixed position indicator fixed to the hub gauge device;
aligning a first moveable caliper jaw with a first flange of the bicycle hub and a second moveable caliper jaw with a second flange of the bicycle hub;
receiving a first moveable caliper jaw position location and a second moveable caliper jaw position location; and
calculating a left flange-to-center dimension and a right flange-to-center dimension by utilizing the first moveable caliper jaw position location and the second moveable caliper jaw position location.

18. The method for determining one or more relevant hub dimensions as recited in claim 17, further comprising the step of displaying the left flange-to-center dimension and the right flange-to-center dimension on one or more display devices.
